(19) United States
(12) Patent Application Publication
(10) Pub. No.: US 2026/0213505 A1
(43) Pub. Date: Jul. 23, 2026

(54) Attachment bracket for attaching stringing block to infrastructure

(71) Applicant: Seekell's Innovations, LLC, Kuna, ID (US)

(72) Inventor: Robert Seekell, Kuna, ID (US)

(21) Appl. No.: 19/458,454

(22) Filed: Jan. 23, 2026

Related U.S. Application Data
(60) Provisional application No. 63/748,856, filed on Jan. 23, 2025.
(60) Provisional application No. 63/832,660, filed on Jun. 30, 2025.

(51) Int. Cl. H02G 1/04

(52) U.S. Cl. CPC H02G 1/04

(57) ABSTRACT

A pinning attachment device for attaching a stringing block to a structure, such as an insulator of an electrical power distribution or transmission system. The device includes a rigging pin configured to extend through a rigging hole of the structure and a gate movable between an open position and a closed position to secure the rigging pin against withdrawal. The gate is biased toward the closed position and is selectively held open during installation by an actuator, such as a drone arm or removable pin, and automatically closes upon removal of the actuator. A mechanical stop cooperates with the rigging pin to prevent premature withdrawal from the structure prior to closure of the gate. A base portion is configured for connection to a stringing block. The device enables rapid, tool-less installation and removal, including remote installation by an aerial drone, without the use of threaded fasteners or cotter pins.

### CROSS-REFERENCE TO RELATED APPLICATIONS

This application claims the benefit of U.S. Provisional Application No. 63/748,856 filed Jan. 23, 2025, and U.S. Provisional Application No. 63/832,660, filed Jun. 30, 2025, the disclosure of each of which is incorporated by reference.

### TECHNICAL FIELD

The presently disclosed technology relates to the field of electrical Power Distribution and transmission or spectacularly it relates to a tool to help string or pull conductors from structure-to-structure weather under an insulator or a tower arm. This tool is an attachment point mechanism that attaches the stringing block to the rigging hole that holds the stringing block in place.

### BACKGROUND

Electrical Power Distribution and transmission lines extend all over the United States. The typical voltage of a distribution circuit is anywhere from 4 KV to 34 five KV. Sub transmission lines carry voltage to distribution substations and can range from 34.5 KV to 69 KV. Large transmission lines from the East Coast to the West Coast supply high voltage from 115 kv to 500 kv to sub transmission substations. In the distribution circuits there will normally be 3 or 4 conductors per circuit on top of utility cross arms mounted to distribution power poles. In the sub transmission voltage and higher transmission voltages there are normally 3 to six conductors per structure.

When a power company is going to install new conductors on a structure weather distribution or transmission circuits the installers install a pulley type string in block to help the conductor when pulled in travel from structure to structure. This work task can be used for new construction or power circuit upgrades for installing new conductor or a larger conductor for grid efficiency. The insulators that hold the conductor, transmission or distribution sometimes has a rigging hole below so a stringing block can be held in place.

When a line worker is attaching the stringing block into the rigging hole the tool they have used for many years requires the lineman to remove a nut and Cotter key and stall into the rigging hole then screw the nut back on and pin with a Cotter key. The current tool is not very efficient, and many lineman sometimes drop the nuts or the cotter keys due to weather conditions or having to wear gloves for safety protocol or policy.

What the power industry needed was a safer, faster, more efficient tool the installers or a drone can attach to structure very easily. A new tool that has no nuts or pins to drop can attach to many different stringing blocks for many different applications. The industry needed a tool that can benefit drone technology that has taken off around the world. A new spring-loaded attachment that will save thousands of dollars on project costs, reduce time in the field, less impact on the environment because Mountainous areas and hard to get to places will be easy to access with a drone.

The typical attachment that has been around for many years cannot mount to a drone has threads/nut and cotter key to install.

In light of the foregoing there is a need for an improved stringing block attachment point that will reduce sprains and strains, repetitive motion injuries, drop injuries, and will be much faster and easier to install. With the new device this will reduce greenhouse gases and reduce emissions because the company will not be required to utilize a truck for installing stringing blocks.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The present disclosure relates to a pinning attachment device for securing a stringing block to a structure, such as an insulator flange used in electrical power distribution and transmission systems. More particularly, the disclosure provides a safer, faster, and more efficient attachment mechanism that eliminates the need for threaded fasteners, loose nuts, or cotter pins, and that is well suited for both manual installation by a lineman and remote installation using an aerial drone.

In one aspect, the pinning attachment device includes a rigging pin configured to extend through a rigging hole formed in a mount, such as an insulator. A gate is associated with the rigging pin and is movable between an open position, in which the rigging pin may be inserted through the rigging hole, and a closed position, in which the gate prevents withdrawal of the rigging pin from the rigging hole. The gate is biased toward the closed position by a spring or other biasing member.

In preferred embodiments, the gate is temporarily retained in the open position by an actuator during installation. The actuator may comprise a drone arm, removable pin, or similar structure inserted through an aperture or otherwise engaged with the gate. Upon removal of the actuator—such as when the drone withdraws from the attachment device—the gate automatically moves to the closed position to secure the rigging pin to the structure.

The device further includes a mechanical stop configured to prevent the rigging pin from sliding out of the rigging hole before the gate closes. The mechanical stop is preferably biased toward a stop position and is configured to be temporarily displaced by contact with a flange of the structure during insertion of the rigging pin. Once the rigging pin is fully seated, the mechanical stop returns to its stop position to prevent reverse movement of the attachment device as the actuator is removed.

The gate may take different forms. In certain embodiments, the gate is a side opening gate, such as a hook that closes onto the rigging pin on one side of the structure flange. In other embodiments, the gate is a front closing gate, such as a plate having an aperture through which the rigging pin extends when the gate is closed. Both configurations are configured to automatically secure the rigging pin upon completion of installation.

A base portion of the attachment device is configured for connection to a stringing block, such as by a bracket and pin arrangement compatible with commercially available stringing blocks. The attachment device may be formed from aluminum, steel, composite materials, or combinations thereof, and the various pins, gates, and springs may be selected to provide durability and long service life under field conditions.

The disclosed pinning attachment device reduces installation time, minimizes dropped-object hazards, decreases repetitive strain and injury risk to workers, and facilitates remote installation in difficult or environmentally sensitive locations. The device is particularly advantageous for drone-assisted installation of stringing blocks in distribution, sub-transmission, and transmission line construction and maintenance operations.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF TH FIGURES

FIG. 1 is a perspective view of a first embodiment of the invention installed on an insulator flange.

FIG. 2 is an isometric partially exploded view of the first embodiment of the invention with the stringing block pin exploded from the base of the device.

FIG. 3 is an isometric side view of the first embodiment of the invention.

FIG. 4 is an isometric view of a side opening gate of the first embodiment of the invention.

FIG. 5 is a second isometric side view of the first embodiment of the invention.

FIG. 6 is a perspective view of the first embodiment coupled to a stringing block and attached to an insulator.

FIG. 7 is a perspective view of the first embodiment of the device coupled to a stringing block being moved toward an insulator for installing the device on and insulator.

FIG. 8 is a perspective view of the assembly of FIG. 7 with the rigging pin partially inserted through the rigging pin hole of the insulator.

FIG. 9 is a perspective view of the assembly of FIGS. 7 and 8 being further installed onto the insulator.

FIG. 10 is a perspective view of the assembly of FIGS. 7-9 with the gat closed securing the device onto the insulator.

FIG. 11 is a perspective elevation view of a second embodiment of the invention.

FIG. 12 is a front elevation view of the embodiment of FIG. 11.

FIG. 13 is a first side elevation view of the embodiment of FIG. 11.

FIG. 14 is a front elevation view of the embodiment of FIG. 11 with the gate in the open position.

FIG. 15 is a side perspective of the embodiment of FIG. 11 being installed onto the flange of an insulator.

FIG. 16 is a side perspective view of the embodiment of FIG. 11.

FIG. 17 is a perspective view of the embodiment of FIG. 11 attached to a stringing block and mounted on an insulator flange.

FIG. 18 illustrates a first view of an action sequence of installing the embodiment of FIG. 11 attached to a stringing block onto an insulator flange.

FIG. 19 illustrates a first view of an action sequence depicted in FIGS. 19-21 of installing the embodiment of FIG. 11 attached to a stringing block onto an insulator flange.

FIG. 20 illustrates a second view of an action sequence of installing the embodiment of FIG. 11 attached to a stringing block onto an insulator flange.

FIG. 21 illustrates a third view of an action sequence of installing the embodiment of FIG. 11 attached to a stringing block onto an insulator flange.

### DETAILED DESCRIPTION OF THE FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

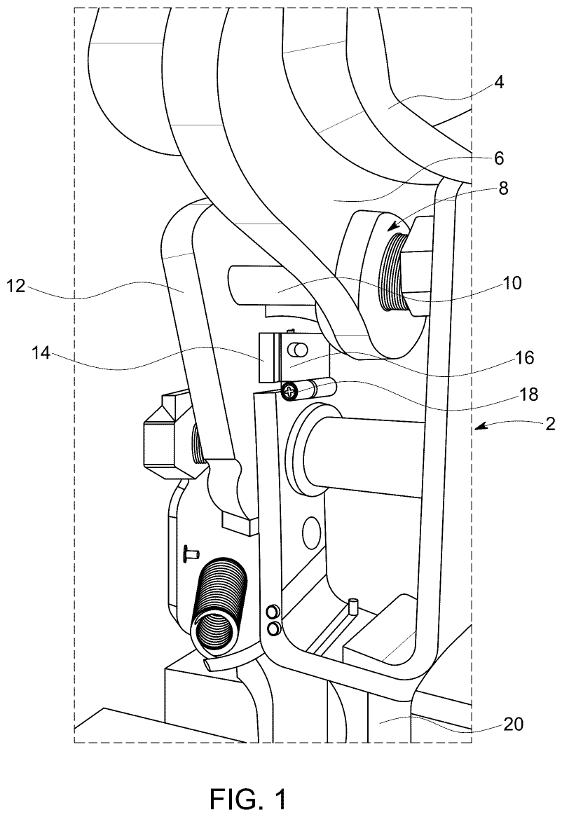

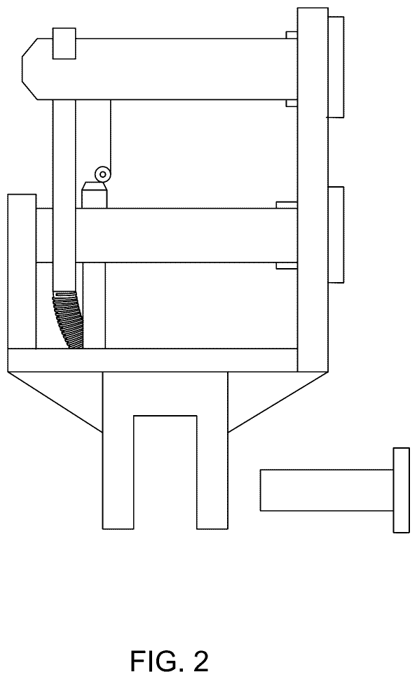

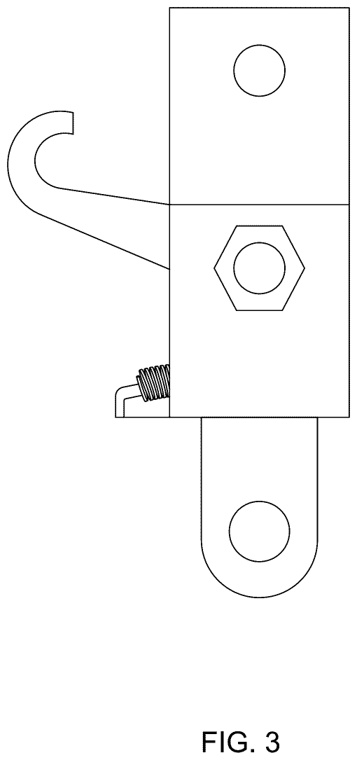

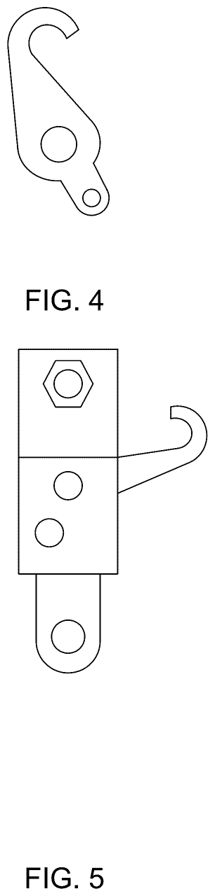

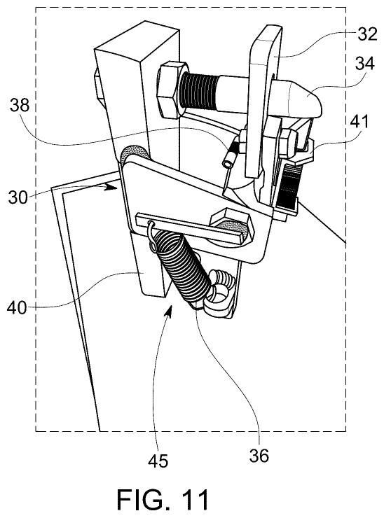

FIGS. 1-10 illustrate a first embodiment of the invention having a side opening gate. FIGS. 11-21 illustrate a second embodiment of the invention having a front opening gate. The new pinning devices are designed for using a drone to attach a stringing block to an insulator. The attachment device is configured for attaching a stringing block beneath the attachment, such that the stringing block extends from the attachment. The attachment is then connected to an insulator serving to connect to the insulator to the stringing block. Preferably the attachment has a bracket having a stringing block aperture that attaches to a stringing block with stringing block pin, typically a ⅝ inch or ¾ inch pin or bolt, although other sizes may be used, to secure the stringing block to the attachment.

The attachment attaches to an insulator by a rigging pin that inserts through the rigging hole of the insulator. This rigging pin is typically ⅝ or ¾ inch diameter, although other could be used. The mechanical stop prevents withdrawal of the rigging pin prior to closure of the gate, thereby maintaining engagement with the mount during actuator removal. This mechanical stop is preferably a spring loaded gate that is biased closed, and as the attachment slides onto the insulator the insulator body pushes the gate open allowing the attachment to slide on to the insulator. The mechanical stop is biased to close once the attachment is functionally attached to the insulator, preventing the reverse action of the attachment sliding off of the insulator as the drone pulls away. This mechanical stop secures the rigging pin in the rigging hole preventing the attachment from sliding off of the insulator as the drone moves away from this insulator.

As the drone moves away, the removal of the drone arm from the attachment actuates a larger gate to close on the rigging pin securing the attachment and stringing block to the insulator. In one embodiment the gate is a hook that attaches to the rigging pin on the opposite side of a flange of the body of the insulator. This is referred to as a side opening gate. The side opening gate can be positioned on one side of the rigging pin, or opposing gates can be used. The side opening gate is biased to close, and removal of the drone arm from the drone arm aperture in the attachment allows the side opening gate to close, securing the attachment to the insulator.

In a second embodiment the gate is front opening gate. In the depicted embodiment the front opening gate is a rectangular or square gate with an aperture such that when the gate is closed, the rigging pin extends through the aperture. The gate prevents removal of the device from the insulator. The gate in an open position is located below and in front of the pin. The arm of the drone holds the gate open, and removal of the drone arm from the drone arm aperture in the attachment body allows the gate to swing shut. This is referred to as a front opening gate.

In the depicted embodiments the gate is manually opened when the attachment is being positioned onto the drone. The drone arm is positioned into the drone arm hole of the attachment, keeping the gate open. The gate is configured to be held open in a preferred embodiment by a gate tab that extends from a base of the gate and engages with the drone arm to hold the gate open.

The insulator has an attachment flange having a rigging hole. The rigging pin of

the attachment device is inserted through the rigging hole. As the drone withdraws from supporting the attachment flange, the drone arm slides out of the attachment device, actuating the gate to close onto the pin, preventing the pin from sliding back out of the aperture.

The installer will be able to hold the heavy duty gate open with their hands when required to install a block manually when needed. The taller side of the device will have a channel hole for a drone to insert the drone arm that holds the heavy duty gate open when the drone is in flight. This arm can be attached to a helicopter or a drone. The new attachment can be used for many different power line stringing blocks from many different manufacturers that are commercially available. The body of the device can be made from aluminum, steel carbon fiber or other materials. The pins can be aluminum, hardened steel or similar materials. The hook mechanism/gate can be of machined aluminum steel or similar material. The spring that holds the gate and the closed position can be of different strengths for longevity of the device.

FIGS. 1-10 illustrate a first embodiment of a pinning attachment device in which the gate is a side opening hook. FIG. 1—A pinning attachment device 2 disclosed to attach a stringing block (not shown) to an insulator 4. The insulator has an attachment flange 6 having a rigging hole aperture 8. The attachment bracket has a rigging pin 10 that is positioned through the aperture to connect the attachment to the insulator. A rigging pin gate 12 in the form of a side opening gate shaped as a hook is closed on the distal end of the pin from attachment point of the pin to the body of the attachment device.

A mechanical stop 14 in the form of a gate 16 prevents the attachment device from sliding off of the insulator until the gate 12 is closed. The mechanical stop 16 is opened by the drone pushing the attachment onto the insulator, causing the mechanical stop 16 to be pushed against the insulator flange 6, opening the stop tab. When the mechanical stop 16 has cleared the insulator flange, the biasing spring 18 causes the mechanical stop 16 to close, preventing the pinning attachment device from sliding off of the insulator as the drone moves away from the insulator. The mechanical stop is configured to be biased toward the extended or closed position, and returns to this position after the force of the insulator flange against the stop has been removed. The mechanical stop cannot rotate in the opposite direction from the closed position, thus if the insulator flange is forced against the back of the mechanical stop, the mechanical stop will not open preventing the rigging pin from sliding out of the insulator.

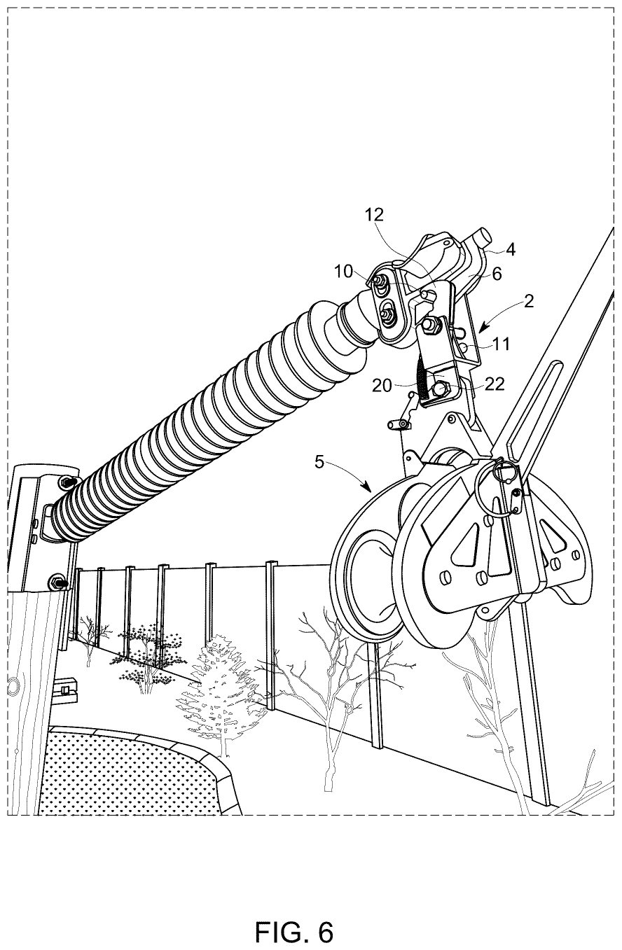

FIG. 6 illustrates an assemble view of an insulator 4 supporting the pinning attachment device 2 of FIGS. 1-5. A stringing block 5 is connected to the attachment device 2 at lower bracket 20. A stringing block pin 22 extends through the bracket and securing a mounting flange of the stringing block. The attachment device 2 has a side opening gate 12 that is shown in the closed position over the attachment rigging pin 10. The attachment rigging pin 10 extends through the connection flange 6 of the insulator 4. In use, a drone attached to the hanging block attachment device is supporting the stringing block supporting device in the opposite side of the view of FIG. 6. The drone arm serves as a gate actuator and extends into the opening 11. The gate 12 is in an open position. As the drone slides rigging pin 10 into and through the aperture in the insulator flange, the mechanical stop opens as the rigging pin 10 slides through the insulator flange. Once the rigging pin is installed, the mechanical stop closes, allowing the drone to withdraw away from the stringing block attachment. As the drone arm slides out of aperture 11, the gate 12 springs closed, securing the attachment device to the insulator.

The mechanical stop swings clockwise in FIG. 1 as a result of force from the flange of the insulator as the pin pushed from right to left. The attachment device has a base 20 formed as a bracket at the bottom of the device for attachment of a stringing block flange to the attachment device. Alternate forms of a stop can be utilized, with the function being to prevent the attachment device rigging pin 10 from sliding off of the flange when the drone withdraws (or a worker manually pulls on a pin that holds open the gate). The gate 12 in the first embodiment has a retaining aperture that connects to an arm of the drone such that the gate 12 is held open until the drone arm is removed. The mechanical stop secures the attachment device in position until the drone arm is withdrawn, allowing the gate 12 to close and securing the attachment device on the insulator.

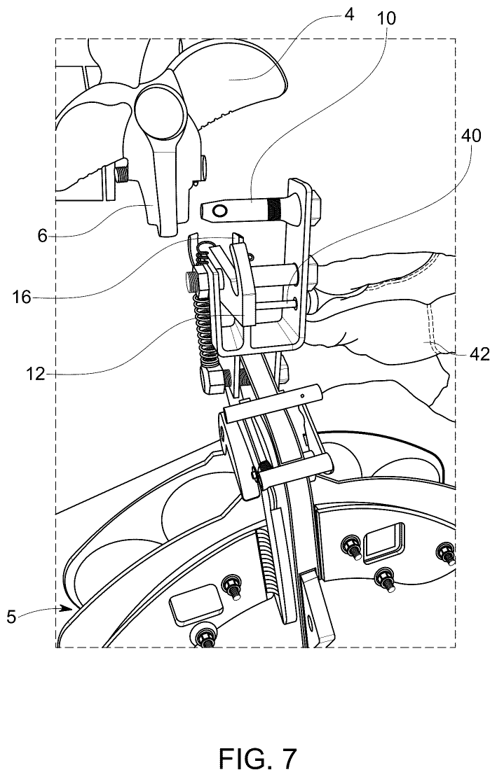

FIGS. 7-10 illustrate an action sequence of a simulated drone positioning the side opening embodiment of a pinning attachment device onto an insulator. In FIG. 7 the attachment device is being moved toward the rigging pin such that rigging pin 10 is moving toward the rigging hole in the flange 6 of the insulator 4. The gloved hand 42 is simulating a drone, although the device can be manually operated with a manually inserted and removed rigging pin. The gloved hand is grasping a drone arm 34 that is inserted in to the drone arm opening of the pinning attachment device. The side opening gate 12 is in the open position and the mechanical stop 16 in the form of a stop tab is extended. The drone arm is securing the side opening gate 12 in the open position.

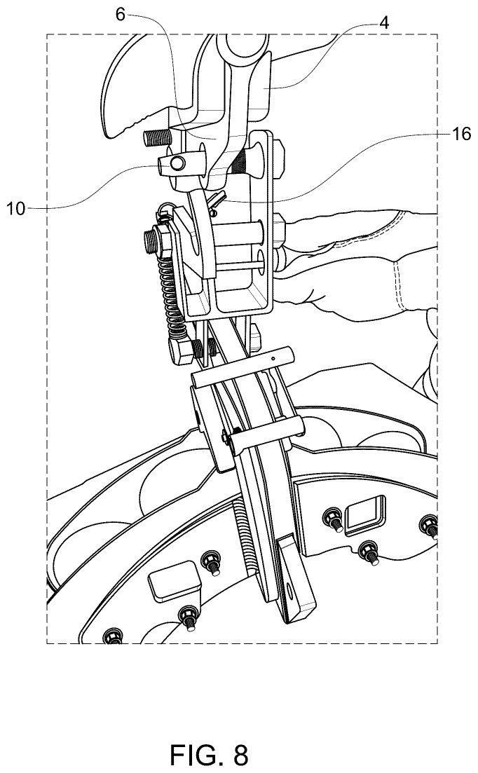

FIG. 8 shows the rigging pin 10 being positioned through the opening in the flange 6 of the insulator 4. The flange 6 of the insulator has partially depressed the mechanical gate 16 as the attachment device slides to the left in the image.

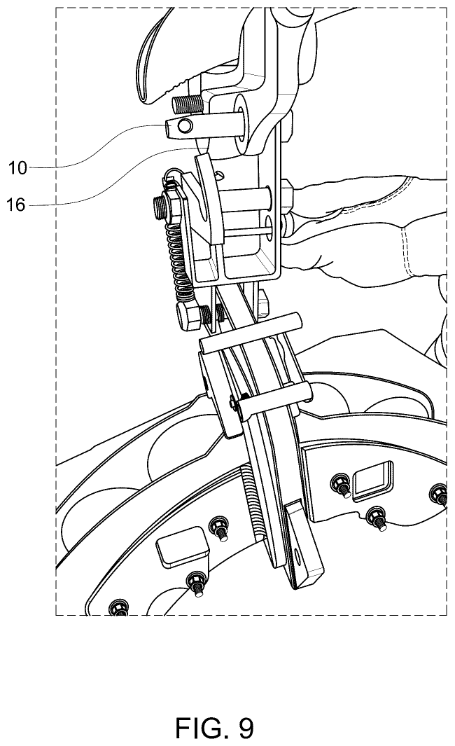

FIG. 9 illustrates a third progressive view in which the rigging pin 10 has been fully positioned into the opening of the insulator. The mechanical stop 16 has rotated back to the extended position. This position prevents the pinning attachment device from sliding to the right such that the pin slides out of the opening in the flange of the insulator.

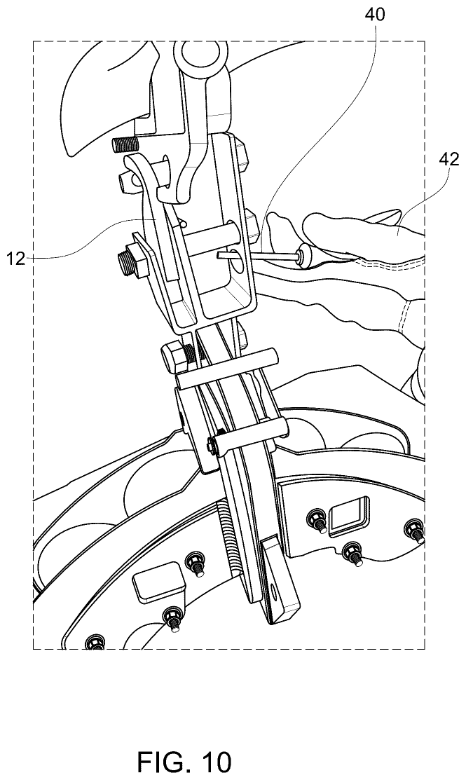

FIG. 10 illustrates a subsequent step of the simulated drone (simulated by glove 42) disengaging and moving away from the pinning attachment device. As the drone moves away, the drone arm 40 is removed from engagement with the side of the gate 12 allowing the gate to biased closed to further secure the pinning attachment device in the insulator. Alternatively the arm 40 can be a pin that is inserted through the aperture 20, and a worker manually removes the arm to allow the gate to bias closed.

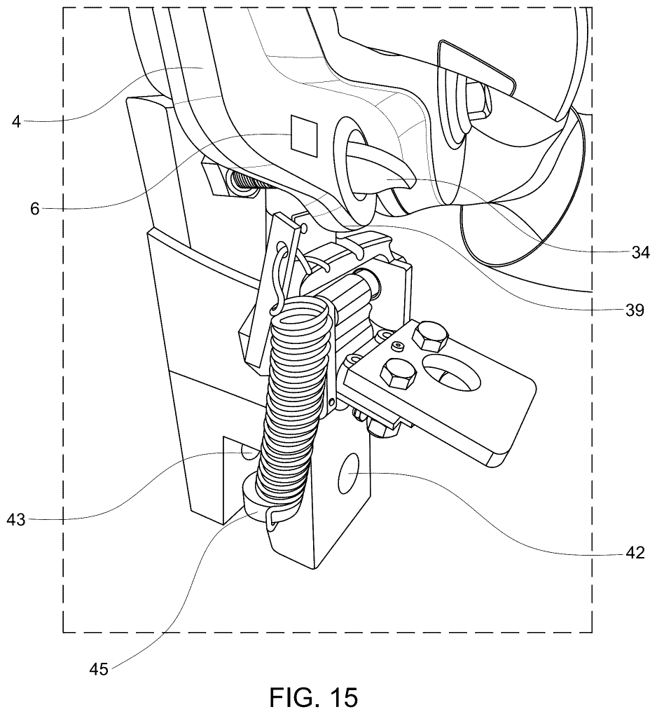

FIGS. 11-21 illustrate a second embodiment of the invention having a front opening gate. FIGS. 11-16 illustrate the attachment device without an attached stringing block. The attachment device 30 has a front opening gate 32 that is biased to the close position shown in FIG. 7. The pin 34 attaches the attachment device to the flange of an insulator as shown in FIG. 15. The device has a mechanical stop 38 that is configured to retain the attachment on the insulator as the drone withdraws from the insulator. In use, the drone slides the attachment device from left toward right with the gate open such that pin 34 extends into the aperture in flange of the insulator. As the attachment device slides toward the insulator, the pin 34 slides into the aperture of the insulator flange until the device is installed on the insulator flange. The sliding of the device causes the insulator flange to press open the mechanical stop 38. Once the flange passes the mechanical stop, the mechanical stop resiliently rebounds to the extended or closed position, preventing the rigging pin from sliding back out of the insulator when the drone withdraws from the attachment device.

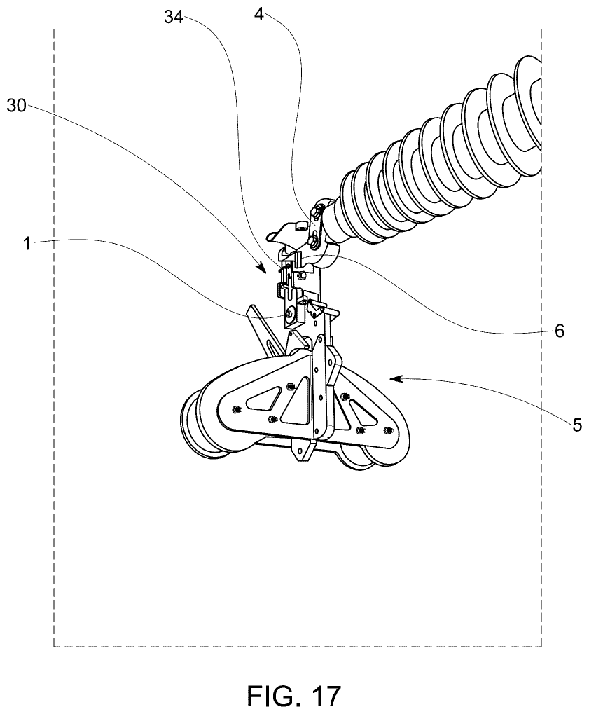

As the drone withdraws from the attachment device, the spring 38 biases the mechanical stop 32 closed as shown in FIG. 11. This mechanical stop prevents the device from being removed from the insulator flange. The base of the device has a bracket 20 that defines opening 45 into which an attachment flange of a stringing block is positioned. A stringing block pin is then inserted through apertures 22, 23 to secure the stringing block to the device. This bracket is illustrated in FIG. 15 and a stringing block is shown attached in FIGS. 17-21.

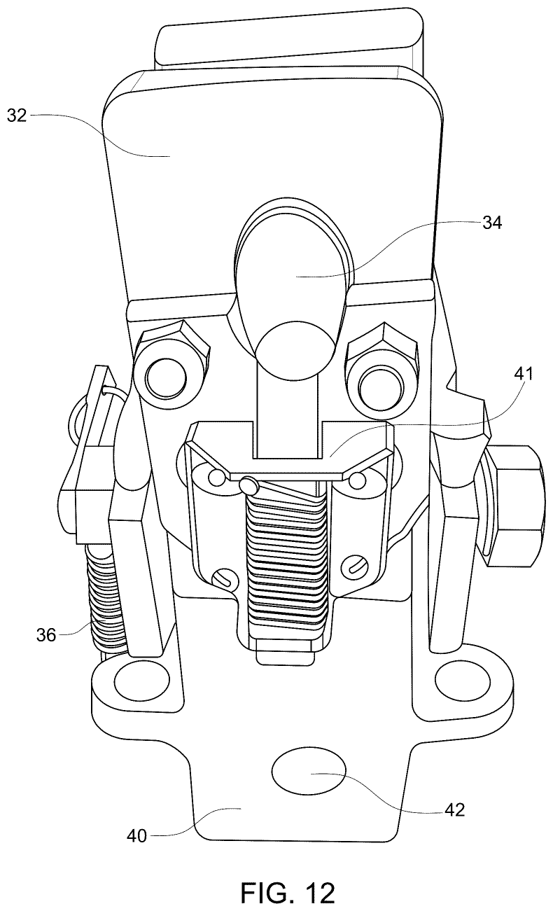

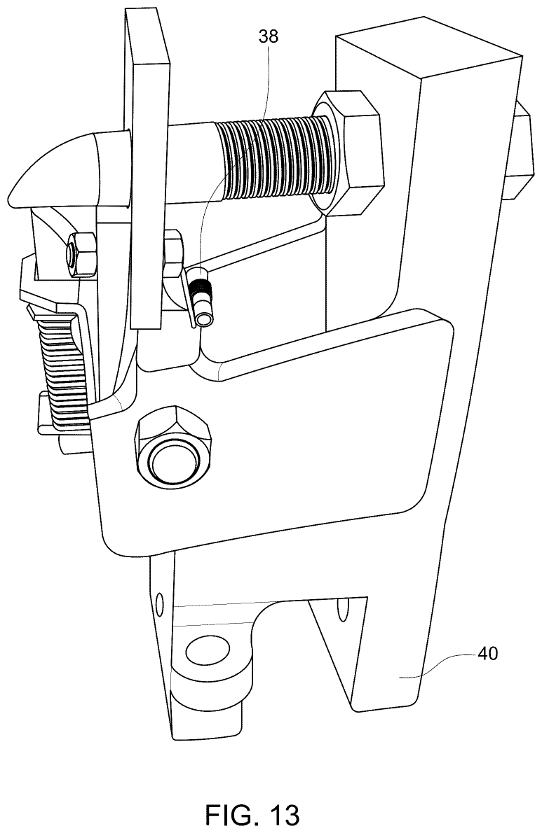

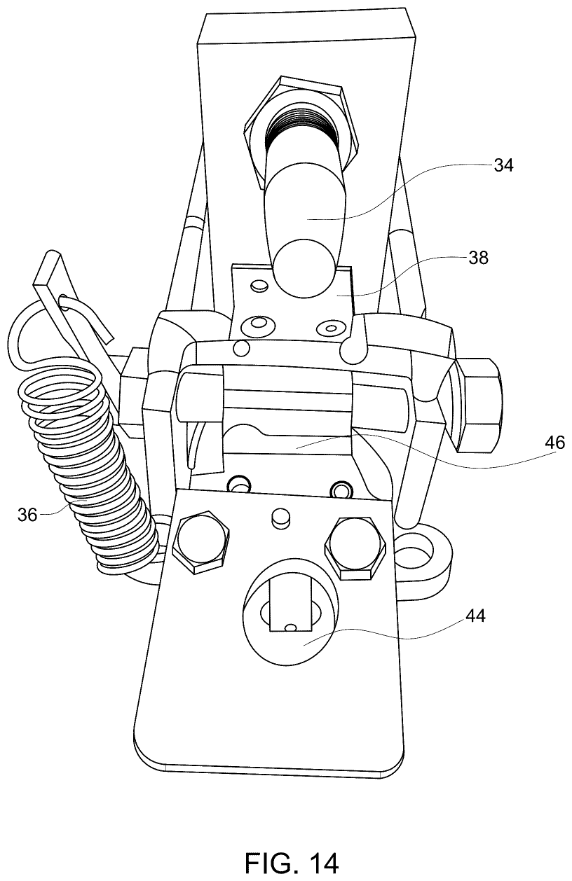

FIG. 14 illustrates the gate in an opened position. The gate has a tab 46 that engages with the drone arm that is inserted into the drone arm aperture 46 of FIG. 12. In use, an operator manually opens the gate and then inserts the device onto the arm of the drone. The drone arm prevents the gate from closing by engaging the tab 46. As the drone arm withdraws from the aperture 47, the spring 36 biases the gate closed such that rigging pin aperture 44 is positioned onto rigging pin 34, securing the device to the insulator flange.

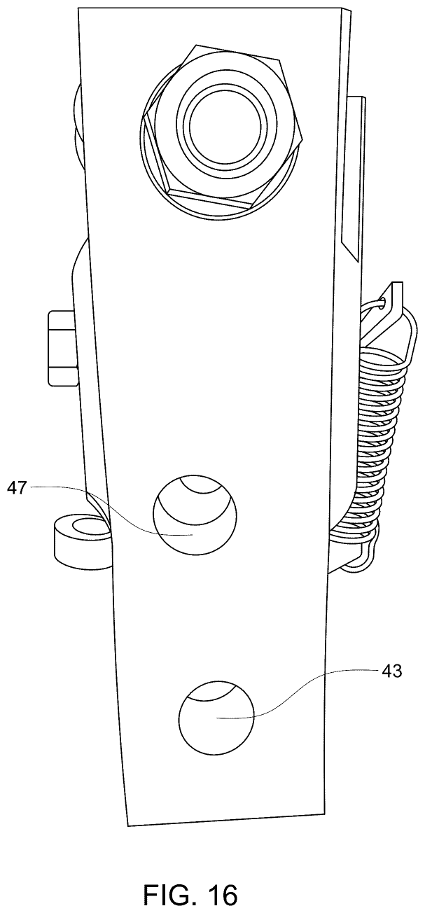

FIG. 16 illustrates the front gate device partially positioned onto an insulator flange 6. The pin 34 has been inserted part way through aperture in the insulator flange 6. Once the insulator flange reaches the mechanical stop, the bottom of the flange pushes the stop open until the flange has passed the mechanical stop. At this point, the stop rebounds and prevents the device from being pulled off of the flange when the drone withdraws. FIG. 17 illustrates an assembly of insulator 4, attachment device 30 of FIGS. 7-12, and a stringing block 5 extended from the attachment device. The stringing block is secure through the stringing block aperture 42 by a stringing block pin 51.

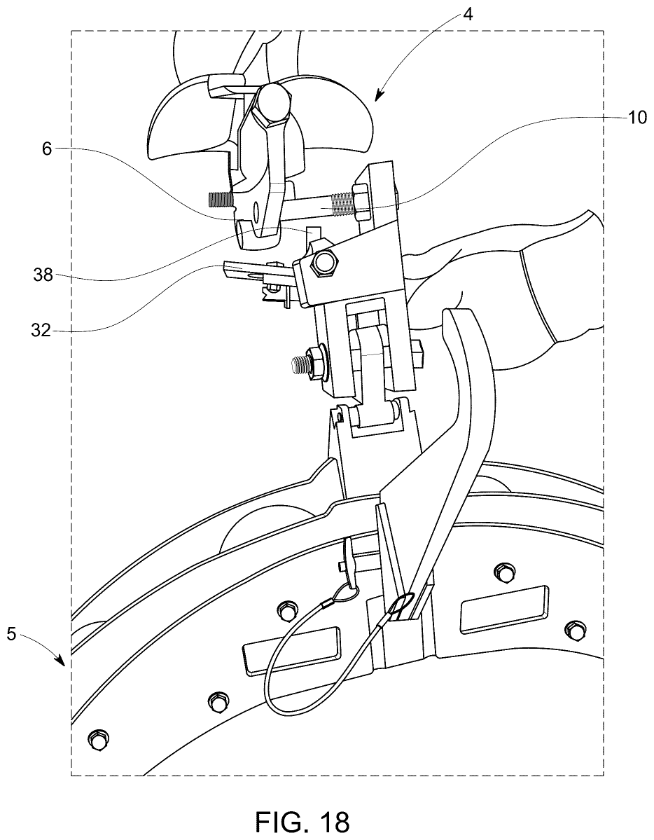

FIGS. 18-21 illustrate an action sequence of the front gate embodiment of the pinning attachment device. In FIG. 18, the rigging pin 10 is beginning to be positioned in the opening of the flange 6 of the insulator 4. As the rigging pin 10 slides into the opening, the pinning attachment device moves to the left of the image. The mechanical stop 38 is shown in the extended position. The front opening gate 32 is in the open position, secured by the drone arm (hidden in FIG. 18). The front opening gate has a tab extending from the base of the gate that is positioned against the top of the drone arm (or manual pin) that prevents the gate from rotating closed. Removal of the drone arm allows the gate to rotate closed.

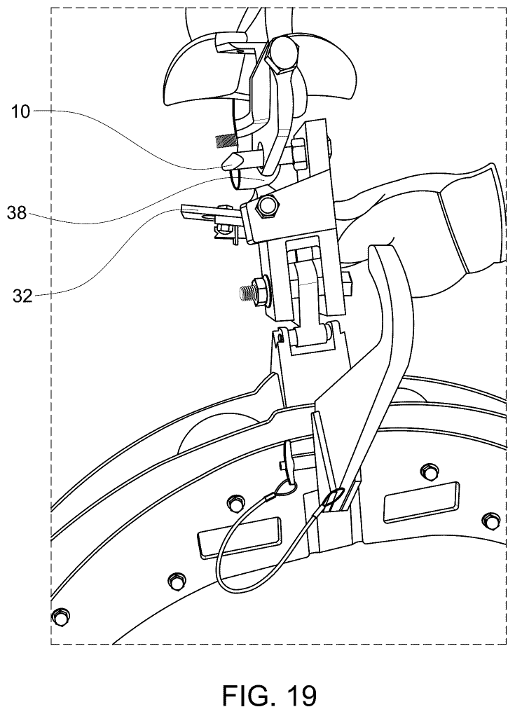

FIG. 19 illustrates a second progressive illustration of the pinning attachment device being positioned onto the insulator. The insulator rigging pin 10 has been positioned partly through the rigging hole in the flange of the insulator. The mechanical stop 38 has been partially rotated open by the flange of the insulator.

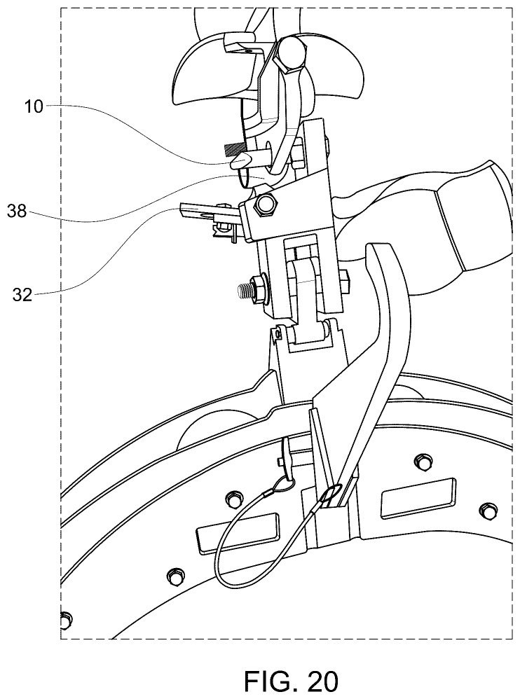

FIG. 20 illustrates the rigging pin positioned fully into the rigging hole in the flange of the insulator. The mechanical stop has cleared the insulator flange and has extended to the closed position. The front opening gate 32 is continued to be held open by the drone arm.

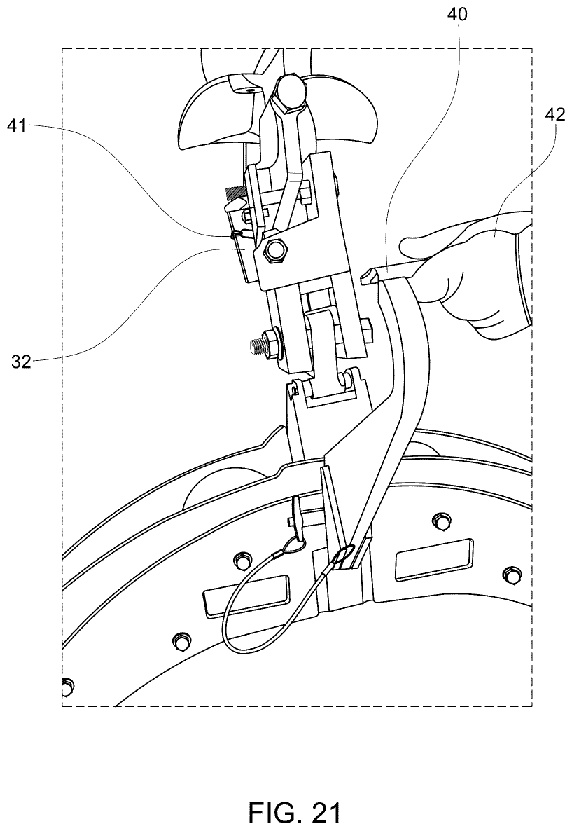

FIG. 21 illustrates the simulated drone pulling away from the pinning attachment device removing the drone arm or arm 34. Removal of the drone arm or arm 34 has allowed the biased front opening gate 32 to spring closed. The locking mechanism, 41 has been biased closed to secure the pinning attachment device onto the rigging pin.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. A pinning attachment device for attaching a stringing block to a mount, said pinning
device comprising:
a rigging pin configured to extend through a rigging hole in the mount;
a gate configured to move from an open position to a closed position to secure said rigging pin in said rigging hole, wherein in an open position the gate is positioned such that said rigging pin can pass through said rigging hole, wherein in a closed position said gate is positioned onto or adjacent to said pin so as to prevent a distal end of said pin from being pulled back through said rigging hole when said rigging pin is positioned through said rigging hole to secure said rigging pin in said rigging hole, wherein said gate is biased to a closed position; and
a base configured for connection to the stringing block.

2. The pinning attachment device of claim 1 further comprising an actuator to release said gate when said gate is in an open position to allow said gate to bias closed.

3. The pinning attachment device of claim 1, wherein said actuator comprises an arm inserted into a gate aperture, wherein removal of said arm allows said gate to close.

4. The pinning attachment device of claim 1 further comprising a mechanical stop configured to prevent said rigging pin from sliding away from said mount prior to said gate closing.

5. The pinning attachment device of claim 1 wherein said gate is a front opening gate.

6. The pinning attachment device of claim 5 wherein said front opening gate comprises a plate with a gate rigging pin aperture.

7. The pinning attachment device of claim 1 wherein said gate is a side opening gate.

8. The pinning attachment device of claim 1 wherein said side opening gate comprises a hook configured to close on said rigging pin.

9. The pinning attachment device of claim 1 wherein said hook is configured to close perpendicular to said rigging pin.

10. The pinning attachment device of claim 1 wherein said gate is biased closed by a gate spring.

11. The pinning attachment device of claim 4 wherein said mechanical stop is biased to a stop position by a stop spring, wherein in said stop position said mechanical stop prevents removal of said rigging pin from said rigging hole.

12. The pinning attachment device of claim 11 wherein said mechanical stop comprises a tab hingedly connected to said pinning attachment device, wherein said tab is configured to rotate open when said rigging pin is inserted into the rigging hole.

13. The pinning attachment device of claim 12 wherein pressure from a flange defining said rigging hole causes said tab to rotate open.

14. The pinning attachment device of claim 1 further comprising a locking mechanism in addition to said gate and configured to further prevent removal of said rigging pin from said rigging hole.

15. The pinning attachment device of claim 14 wherein said locking mechanism comprises a lock pin aperture configured for receiving a lock pin through said rigging pin.

16. The pinning attachment device of claim 15 further comprising the lock pin inserted through said lock pin aperture.

17. The pinning attachment of claim 14 wherein said locking mechanism comprises a

18. The pinning attachment of claim 1 wherein said base comprises a bracket configured for connection to the stringing block.

19. The pinning attachment of claim 1 wherein said base is configured for attachment to a flange of the stringing block.
